(19) United States
(12) Patent Application Publication
(10) Pub. No.: US 2018/0342782 A1
(43) Pub. Date: Nov. 29, 2018

(54) DATA TRANSMISSION SYSTEM

(71) Applicant: Altek Semiconductor Corp., Hsinchu City (TW)

(72) Inventor: Yu-Kuo Tai, Hsinchu City (TW)

(73) Assignee: Altek Semiconductor Corp., Hsinchu City (TW)

(21) Appl. No.: 15/694,852

(22) Filed: Sep. 4, 2017

(30) Foreign Application Priority Data
May 26, 2017 (TW) 106117529

(51) Int. Cl. H01P 5/12

(52) U.S. Cl. CPC H01P 5/12; H04B 1/16

(57) ABSTRACT

A data transmission system including a plurality of transmitters, a receiver and a power combining circuit is provided. The transmitters have a first transmitting end and a second transmitting end, respectively. The receiver has a first receiving end and a second receiving end. The power combining circuit is coupled between the first transmitting ends and the second transmitting ends of the transmitters and the first receiving end and the second receiving end of the receiver, and has a plurality of power combiners to couple the first transmitting ends of the transmitters to the first receiving end of the receiver and couple the second transmitting ends of the transmitters to the second receiving end of the receiver.

### CROSS-REFERENCE TO RELATED APPLICATION

This application claims the priority benefit of Taiwan application serial no. 106117529, filed on May 26, 2017. The entirety of the above-mentioned patent application is hereby incorporated by reference herein and made a part of this specification.

### BACKGROUND OF THE INVENTION

### Field of the Invention

The invention relates to a data transmission system, and more particularly relates to a high-speed data transmission system.

### Description of Related Art

With the development of technology, various types of smart image capturing devices, such as tablet computers, personal digital assistants, smartphones, etc., have become indispensable tools for modern people. Therein, an image data captured by a camera head of a camera lens can be transmitted to a main controller through a mobile industry processor interface (MIPI). In addition, with improvements in imaging technology, the camera lens adopted for high-end models of smart image capturing devices have gradually increased.

The original design of MIPI is a high-speed “peer-to-peer” data transmission, that is, one outputter can only connect to one receiver. If the MIPI is applied to two or more transmitter (TX) sources to transmit to one receiver (RX) through time-division multiplexing, there is a certain difficulty to achieve the same with existing technology, or a high cost manner is required to achieve the same. Therefore, how to achieve transmitting a plurality of TX sources to a single receiver in a simple and low cost manner is a technical focus still requiring a breakthrough for people skilled in the art.

### SUMMARY OF THE INVENTION

The invention provides a data transmission system coupling a plurality of transmitters to a single receiver in a simple and low cost manner.

The data transmission system of the invention includes the plurality of transmitters, the receiver and a power combining circuit. The plurality of transmitters have a first transmitting end and a second transmitting end, respectively. The receiver has a first receiving end and a second receiving end. The power combining circuit is coupled between the first transmitting ends and the second transmitting ends of the plurality of transmitters and the first receiving end and the second receiving end of the receiver, and has a plurality of power combiners to couple the first transmitting ends of the plurality of transmitters to the first receiving end of the receiver and couple the second transmitting ends of the plurality of transmitters to the second receiving end of the receiver.

Accordingly, the data transmission system of embodiments of the invention couples the transmitters to the receiver through the power combiners so as to achieve impedance matching and control of a signal network without requiring an additional control signal to be added. Since the power combiners have simple circuit structure, the same have very low design costs.

To make the above and other features and advantages of the invention more comprehensible, embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a system schematic diagram of a data transmission system according to an embodiment of the invention.

FIG. 2 a system schematic diagram of a data transmission system according to another embodiment of the invention.

FIG. 3 a system schematic diagram of a data transmission system according to yet another embodiment of the invention.

### DESCRIPTION OF THE EMBODIMENTS

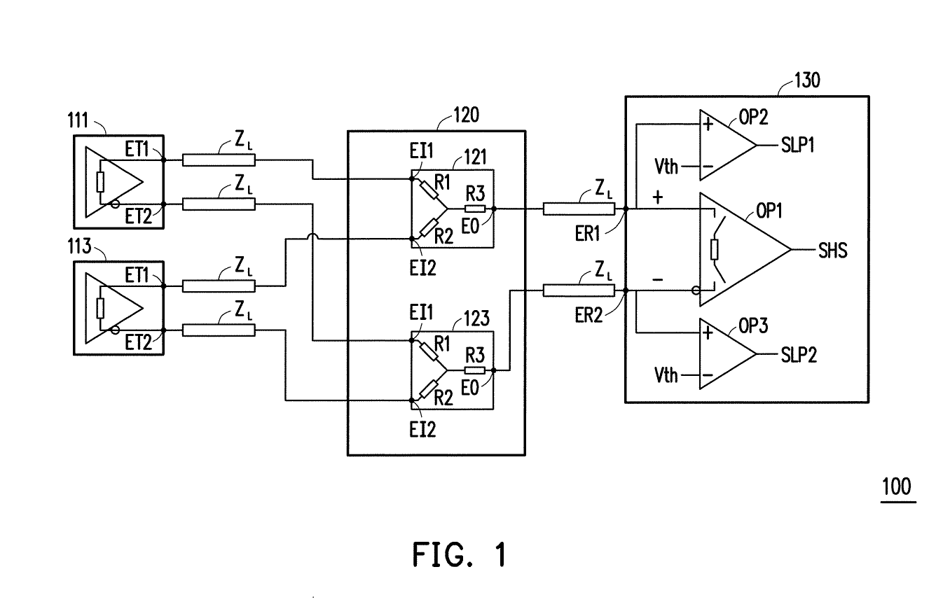

FIG. 1 is a system schematic diagram of a data transmission system according to an embodiment of the invention. Referring to FIG. 1, in the embodiment, a data transmission system 100 is applicable between a sensor and a main controller, such as between a camera head of a camera lens and an application processor. The data transmission system 100 includes a plurality of transmitters (herein, two transmitters 111 and 113 are adopted as examples), a power combining circuit 120 and a receiver 130, wherein the power combining circuit 120 has a plurality of power combiners (herein, two power combiners 121 and 123 are adopted as examples). In addition, the transmitters 111 and 113 are respectively a mobile industry processor interface (MIPI) transmitter, the receiver 130 is an MIPI receiver, and an impedance Z_{L} is a line impedance.

The transmitters 111 and 113 have a first transmitting end ET1 and a second transmitting end ET2, respectively. The receiver 130 has a first receiving end ER1 and a second receiving end ER2. The first transmitting ends ET1 of the transmitters 111 and 113 are coupled to the first receiving end ER1 of the receiver 130 through the power combiner 121, and second transmitting ends ET2 of the transmitters 111 and 113 are coupled to the second receiving end ER2 of the receiver 130 through the power combiner 123. Accordingly, when the data transmission system 100 has two transmitters, the power combining circuit 120 correspondingly has two power combiners.

More specifically, the power combiners 121 and 123 have a first input end EI1, a second input end EI2, and an output end EO, respectively. The first input end EI1 of the power combiner 121 (corresponding to a first power combiner) is coupled to the first transmitting end ET1 of the transmitter 111 (corresponding to a first transmitter), the second input end EI2 of the power combiner 121 is coupled to the first transmitting end ET1 of the transmitter 113 (corresponding to a second transmitter), and the output end EO of the power combiner 121 is coupled to the first receiving end ER1 of the receiver 130. The first input end EI1 of the power combiner 123 (corresponding to a second power combiner) is coupled to the second transmitting end ET2 of the transmitter 111, the second input end EI2 of the power combiner 123 is coupled to the second transmitting end ET2 of the transmitter 113, and the output end EO of the power combiner 123 is coupled to the second receiving end ER2 of the receiver 130.

In addition, the power combiners 121 and 123 are herein exemplified as resistive power combiners, namely the power combiners 121 and 123 include resistors R1 to R3 (corresponding to a first resistor to a third resistor), respectively. A first end of the resistor R1 is coupled to the first input end EI1. The resistor R2 is coupled between a second end of the resistor R1 and the second input end ET2. The resistor R3 is coupled between the second end of the resistor R1 and the output end EO. In other words, the power combiners 121 and 123 are herein formed by adopting a Y-shaped resistor network, but the embodiment of the invention is not limited thereto.

Generally, MIPI transmission is divided as a low power (LP) mode (which is a low speed state) and a high speed (HS) mode (which is a high speed state). According to the standard regulations of MIPI transmitter (TX), in the low power mode and OFF state, an output of the transmitter presents high impedance, whereas in the high speed mode, the output end of the transmitter presents a differential impedance of 100 ohms.

As shown in FIG. 1, when the transmitter 111 outputs a signal, the transmitter 113 is configured to not output a signal, and thus the output end (namely between the first transmitting end ET1 and the second transmitting end ET2) of the transmitter 113 presents a high impedance state. In contrast, when the transmitter 113 outputs a signal, the transmitter 111 is configured to not output a signal, and thus the output end (namely between the first transmitting end ET1 and the second transmitting end ET2) of the transmitter 111 presents a high impedance state.

The output end (namely the first transmitting end ET1 and the second transmitting end ET2) of each of the transmitters (such as 111 and 113) connects to the input end (namely the first input end EI1 and the second input end EI2) of the power combiners 121 and 123 through a transmission line with the line impedance Z_{L} being a characteristic impedance of 50 ohms (or differential 100 ohms). The signal of the transmitters (such as 111 and 113) is then connected from the output end EO of the power combiners 121 and 123 to the input end (namely the first receiving end ER1 and the second receiving end ER2) of the receiver 130. The impedance seen by the input end (namely the first input end EI1 and the second input end EI2) of each of the power combiners 121 and 123 is close to 50 ohms (or differential 100 ohms), and the impedance seen by the output end EO of the power combiners 121 and 123 is also close to 50 ohms (or differential 100 ohms), thereby maintaining the impedance matching of the data transmission system 100.

Since the power combiners 121 and 123 of the embodiment are resistive power combiners (namely passive power combiners), the same have very low design costs. In addition, regarding MIPI bandwidth requirements, the resistive power combiners are formed using the resistors (such as R1 to R3). The frequency response of the resistors has a quite broad flat region. Accordingly, bandwidth requirements from 10 MHz to 3 GHz can all be satisfied.

However, the resistive power combiners being formed using the resistors (such as R1 to R3) can cause the signal of the transmitters (such as 111 and 113) to be weakened (for example, weakened by 3 dB to 6 dB). Therefore, if the signal received by the input end of the receiver 130 is too weak, a gain value of a differential amplifier OP1 of the receiver 130 can be adjusted to increase sensitivity of the signal reception.

In the embodiment, the receiver 130, for example, includes differential amplifiers OP1 to OP3, wherein the differential amplifier OP1 is configured to sample the signal in the high speed mode to obtain a high speed signal SHS, and the differential amplifiers OP2 and OP3 are configured to sample the signal in the low power mode to obtain low power signals SLP1 and SLP2. Herein, the differential amplifiers OP2 and OP3 receive a threshold voltage Vth so as to sample the signal.

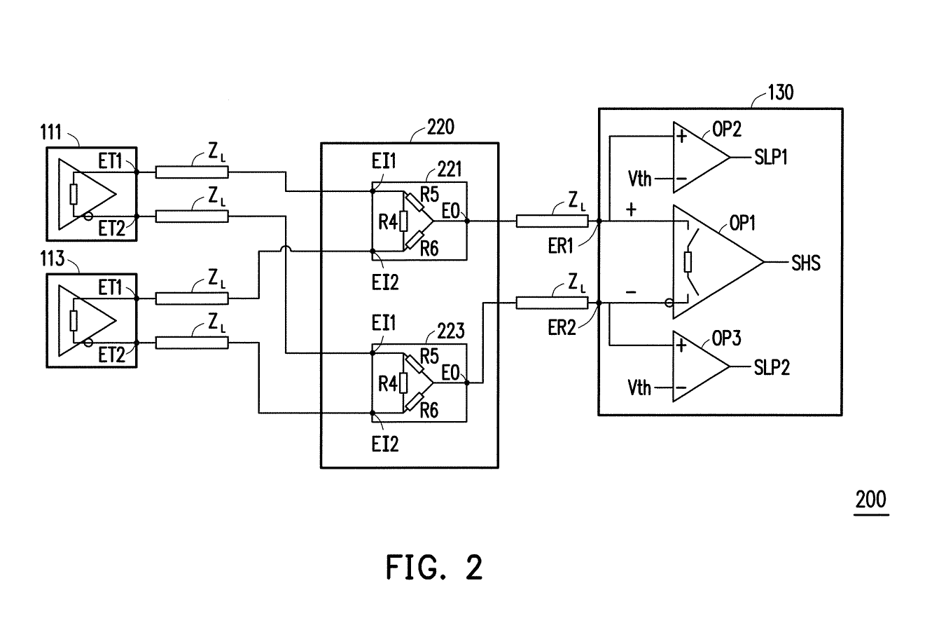

FIG. 2 a system schematic diagram of a data transmission system according to another embodiment of the invention. Referring to FIG. 1 and FIG. 2, a data transmission system 200 is roughly identical to the data transmission system 100 with a difference thereof lying in power combiners 221 and 223 of a power combining circuit 220, wherein the same or similar elements adopt the same or similar reference numerals. In the embodiment, the power combiners 221 and 223 is formed by adopting a Δ-shaped resistor network, namely the power combiners 221 and 223 include resistors R4 to R6 (corresponding to a fourth resistor to a sixth resistor). The resistor R4 is coupled between the first input end EI1 and the second input end EI2. The resistor R5 is coupled between the first input end EI1 and the output end EO. The resistor R6 is coupled between the second input end EI2 and the output end EO.

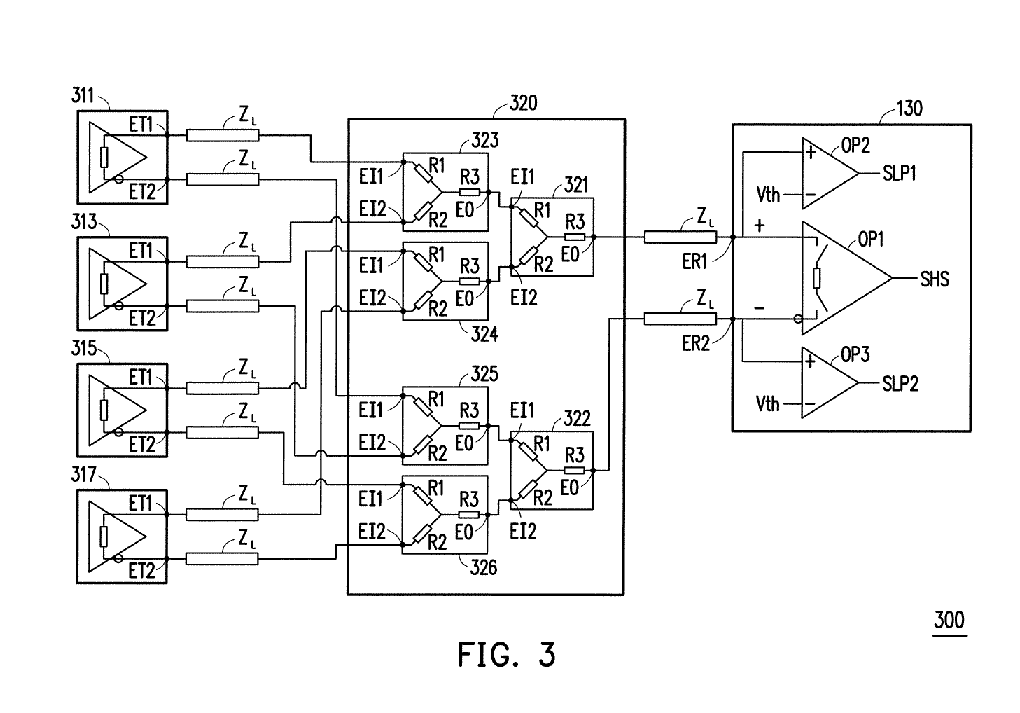

FIG. 3 a system schematic diagram of a data transmission system according to yet another embodiment of the invention. Referring to FIG. 1 and FIG. 3, a data transmission system 300 is roughly identical to the data transmission system 100, wherein the same or similar elements adopt the same or similar reference numerals. In the embodiment, the data transmission system 300 includes four transmitters 311, 313, 315 and 317, and a power combining circuit 320 has six power combiners 321 to 326, wherein the power combiners 321 to 326 are, for example, formed by a Δ-shaped resistor network, namely referring to the power combiners 121 and 123 as shown in FIG. 1, but in other embodiments, can also be formed by a Y-shaped resistor network, namely the power combiners 221 and 223 as shown in FIG. 2.

The first transmitting ends ET1 of the transmitters 311, 313, 315 and 317 are coupled to the first receiving end ER1 of the receiver 130 through the power combiners 321, 323 and 324, and the second transmitting ends ET2 of the transmitters 311, 313, 315 and 317 are coupled to the second receiving end ER2 of the receiver 130 through the power combiners 322, 325 and 326. Accordingly, when the data transmission system 300 has four transmitters, the power combining circuit 320 correspondingly has six power combiners.

More specifically, the power combiners 321 to 326 have the first input end EI1, the second input end EI2, and the output end EO, respectively. The first input end EI1 of the power combiner 323 (corresponding to a third power combiner) is coupled to the first transmitting end ET1 of the transmitter 311 (corresponding to a first transmitter), and the second input end EI2 of the power combiner 323 is coupled to the first transmitting end ET1 of the transmitter 313 (corresponding to a third transmitter).

The first input end EI1 of the power combiner 324 (corresponding to a fourth power combiner) is coupled to the first transmitting end ET1 of the transmitter 315 (corresponding to a second transmitter), and the second input end EI2 of the power combiner 324 is coupled to the first transmitting end ET1 of the transmitter 317 (corresponding to a fourth transmitter).

The first input end EI1 of the power combiner 321 (corresponding to a first power combiner) is coupled to the output end EO of the power combiner 323, namely coupled to the first transmitting ends ET1 of the transmitters 311 and 313 through the power combiner 323. The second input end EI2 of the power combiner 321 is coupled to the output end EO of the power combiner 324, namely coupled to the first transmitting ends ET1 of the transmitters 315 and 317 through the power combiner 324. The output end EO of the power combiner 321 is coupled to the first receiving end ER1 of the receiver 130.

The first input end EI1 of the power combiner 325 (corresponding to a fifth power combiner) is coupled to the second transmitting end ET2 of the transmitter 311, and the second input end EI2 of the power combiner 325 is coupled to the second transmitting end ET2 of the transmitter 313. The first input end EI1 of the power combiner 326 (corresponding to a sixth power combiner) is coupled to the second transmitting end ET2 of the transmitter 315, and the second input end EI2 of the power combiner 326 is coupled to the second transmitting end ET2 of the transmitter 317.

The first input end EI1 of the power combiner 322 (corresponding to a second power combiner) is coupled to the output end EO of the power combiner 325, namely coupled to the second transmitting ends ET2 of the transmitters 311 and 313 through the power combiner 325. The second input end EI2 of the power combiner 322 is coupled to the output end EO of the power combiner 326, namely coupled to the second transmitting ends ET2 of the transmitters 315 and 317 through the power combiner 326. The output end EO of the power combiner 322 is coupled to the second receiving end ER2 of the receiver 130.

As shown in FIG. 3, the resistive power combiners being formed using the resistors (such as R1 to R3) can cause the signal of the transmitters (such as 311, 313, 315, and 317) to be weakened several times. Therefore, if the signal received by the input end of the receiver 130 is too weak, the gain value of the differential amplifier OP1 of the receiver 130 can be adjusted to increase sensitivity of the signal reception. In addition, an extent of increase of the gain value and the sensitivity of the differential amplifier OP1 as shown in the embodiment of FIG. 3 is greater than an extent of increase of the gain value and the sensitivity of the differential amplifier OP1 as shown in the embodiment of FIG. 1, namely the sensitivity and the gain value of the differential amplifier OP1 is directly proportional to a quantity of the power combiners (121, 123, 221, 223, and 321 to 326) in the power combining circuit (such as 120, 220 and 320).

In summary of the above, the data transmission system of the embodiments of the invention couples the transmitters to the receiver through the power combiners so as to achieve impedance matching and control of the signal network without requiring an additional control signal to be added. Since the power combiners have simple circuit structure, the same have very low design costs, and the traces of the layout of the printed circuit board (PCB) are easier, while signal integrity is higher. In addition, through the resistive power combiners, the MIPI bandwidth requirements can be satisfied, and good signal integrity can be obtained.

Although the invention has been described with reference to the above embodiments, it will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A data transmission system comprising:
a plurality of transmitters having a first transmitting end and a second transmitting end, respectively;
a receiver having a first receiving end and a second receiving end; and
a power combining circuit being coupled between the first transmitting ends and the second transmitting ends of the plurality of transmitters and the first receiving end and the second receiving end of the receiver, and having a plurality of power combiners to couple the first transmitting ends of the plurality of transmitters to the first receiving end of the receiver and couple the second transmitting ends of the plurality of transmitters to the second receiving end of the receiver.

2. The data transmission system according to claim 1, wherein each of the plurality of power combiners have a first input end, a second input end, and an output end.

3. The data transmission system according to claim 2, wherein when the plurality of transmitters comprise a first transmitter and a second transmitter, the plurality of power combiners comprise a first power combiner and a second power combiner, wherein the first input end of the first power combiner is coupled to the first transmitting end of the first transmitter, the second input end of the first power combiner is coupled to the first transmitting end of the second transmitter, the output end of the first power combiner is coupled to the first receiving end of the receiver, the first input end of the second power combiner is coupled to the second transmitting end of the first transmitter, the second input end of the second power combiner is coupled to the second transmitting end of the second transmitter, the output end of the second power combiner is coupled to the second receiving end of the receiver.

4. The data transmission system according to claim 3, wherein when the plurality of transmitters further comprise a third transmitter and a fourth transmitter, the plurality of power combiners further comprise a third power combiner, a fourth power combiner a fifth power combiner, and a sixth power combiner, wherein the first input end of the third power combiner is coupled to the first transmitting end of the first transmitter, the second input end of the third power combiner is coupled to the first transmitting end of the third transmitter, the output end of the third power combiner is coupled to the first input end of the first power combiner, the first input end of the fourth power combiner is coupled to the first transmitting end of the second transmitter, the second input end of the fourth power combiner is coupled to the first transmitting end of the fourth transmitter, the output end of the fourth power combiner is coupled to the second input end of the first power combiner, the first input end of the fifth power combiner is coupled to the second transmitting end of the first transmitter, the second input end of the fifth power combiner is coupled to the second transmitting end of the third transmitter, the output end of the fifth power combiner is coupled to the first input end of the second power combiner, the first input end of the sixth power combiner is coupled to the second transmitting end of the second transmitter, the second input end of the sixth power combiner is coupled to the second transmitting end of the fourth transmitter, the output end of the sixth power combiner is coupled to the second input end of the second power combiner.

5. The data transmission system according to claim 2, wherein the plurality of power combiners are a resistive power combiner, respectively.

6. The data transmission system according to claim 5, wherein each of the plurality of power combiners comprises:
a first resistor having a first end coupling to the first input end and a second end;
a second resistor being coupled between the second end of the first resistor and the second input end; and
a third resistor being coupled between the second end of the first resistor and the output end.

7. The data transmission system according to claim 5, wherein each of the plurality of power combiners comprises:
a fourth resistor being coupled between the first input end and the second input end;
a fifth resistor being coupled between the first input end and the output end; and
a sixth resistor being coupled between the second input end and the output end.

8. The data transmission system according to claim 1, wherein the plurality of transmitters are respectively a mobile industry processor interface (MIPI) transmitter, and the receiver is an MIPI receiver.

9. The data transmission system according to claim 1, wherein the receiver has at least one differential amplifier, and a sensitivity and a gain value of the at least one differential amplifier is directly proportional to a quantity of the plurality of power combiners.
